(19) United States
(12) Patent Application Publication
(10) Pub. No.: US 2016/0334737 A1
(43) Pub. Date: Nov. 17, 2016

(54) BELT DEVICE AND IMAGE FORMING APPARATUS INCORPORATING SAME

(71) Applicants: Mitsutoshi KICHISE, Osaka (JP); Takeshi YAMASHITA, Osaka (JP); Kazuki MATSUMOTO, Osaka (JP)

(72) Inventors: Mitsutoshi KICHISE, Osaka (JP); Takeshi YAMASHITA, Osaka (JP); Kazuki MATSUMOTO, Osaka (JP)

(21) Appl. No.: 15/152,940

(22) Filed: May 12, 2016

(30) Foreign Application Priority Data
May 12, 2015 (JP) 2015-097359

(51) Int. Cl. G03G 15/16

(52) U.S. Cl. CPC G03G 15/161

(57) ABSTRACT

A belt device includes an endless belt, a presser, a cleaner, and a seal. The endless belt bears an image or a recording medium. The presser is disposed in contact with each end of the belt in a lateral direction of the belt. The cleaner contacts the belt to clean a surface of the belt. The seal is disposed on one end or both ends of the cleaner in the lateral direction of the belt. The seal has an inner end inside the belt in the lateral direction of the belt. An exposure area is disposed on an inner side of each end of the belt in the lateral direction of the belt. The presser and the seal are disposed on an outer side of an image area, in which an image is formed, and on an outer side of the exposure area in the lateral direction of the belt.

### CROSS-REFERENCE TO RELATED APPLICATION

This patent application is based on and claims priority pursuant to 35 U.S.C. §119(a) to Japanese Patent Application No. 2015-097359, filed on May 12, 2015, in the Japan Patent Office, the entire disclosure of which is hereby incorporated by reference herein.

### BACKGROUND

1. Technical Field

Aspects of the present disclosure relate to a belt device and an image forming apparatus, such as a copier, a printer, a facsimile machine, or a multifunction peripheral including at least one of the copier, the printer, and the facsimile machine, incorporating the belt device.

2. Related Art

An image forming apparatus, such as a copier, a printer, a facsimile machine, or a multifunction peripheral including at least one of the foregoing capabilities, may include a belt device that includes, for example, an endless belt, such as a transfer belt, to transfer an image, which is transferred from a latent image bearer, onto a recording medium, a presser to press both ends of the belt to restrict movement in a lateral direction (lateral width direction) of the belt, and a cleaner to clean the surface of the belt.

### SUMMARY

In an aspect of the present disclosure, there is provided a belt device that includes an endless belt, a presser, a cleaner, and a seal. The endless belt bears an image or a recording medium to which an image is transferred. The presser is disposed in contact with each end of the belt in a lateral direction of the belt. The cleaner contacts the belt to clean a surface of the belt. The seal is disposed on one end or both ends of the cleaner in the lateral direction of the belt. The seal has an inner end inside the belt in the lateral direction of the belt. An exposure area is disposed on an inner side of each end of the belt in the lateral direction of the belt. The presser and the seal are disposed on an outer side of an image area, in which an image is formed, and on an outer side of the exposure area in the lateral direction of the belt.

In another aspect of the present disclosure, there is provided an image forming apparatus that includes the belt device.

### BRIEF DESCRIPTION OF THE SEVERAL VIEWS OF THE DRAWINGS

The aforementioned and other aspects, features, and advantages of the present disclosure would be better understood by reference to the following detailed description when considered in connection with the accompanying drawings, wherein:

FIG. 1 is a schematic view of a configuration of an image forming apparatus;

FIG. 2 is a perspective view of a flange provided on an end of an intermediate transfer belt;

FIG. 3 is a cross-sectional view of a presser provided on the end of the intermediate transfer belt;

FIG. 4 is a schematic view of a transfer belt device illustrating a problem to be solved by the present embodiment;

FIG. 5 is a schematic view of a transfer belt device illustrating a problem to be solved by the present embodiment;

FIG. 6 is a schematic view of a transfer belt device illustrating a problem to be solved by the present embodiment;

FIG. 7 is a perspective view illustrating how toner is deposited on the presser;

FIG. 8 is a schematic view of illustrating a transfer belt device according to an embodiment of the present disclosure;

FIG. 9 is an enlarged view of a periphery of the flange;

FIG. 10 is a schematic view of a transfer belt device illustrating a problem to be solved by the present embodiment;

FIG. 11 is an enlarged view of a cleaning blade end;

FIG. 12 is a schematic view of a configuration of seals;

FIG. 13 is an enlarged view of a periphery of the seal for illustrating deformation of a seal; and

FIG. 14 is a schematic view of a configuration of a conventional image forming apparatus.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

Hereinafter, an embodiment according to the present disclosure will be described referring to the drawings. Note that, in the drawing, the same or an equivalent part is assigned the same reference code, and the duplicated description is appropriately simplified or omitted.

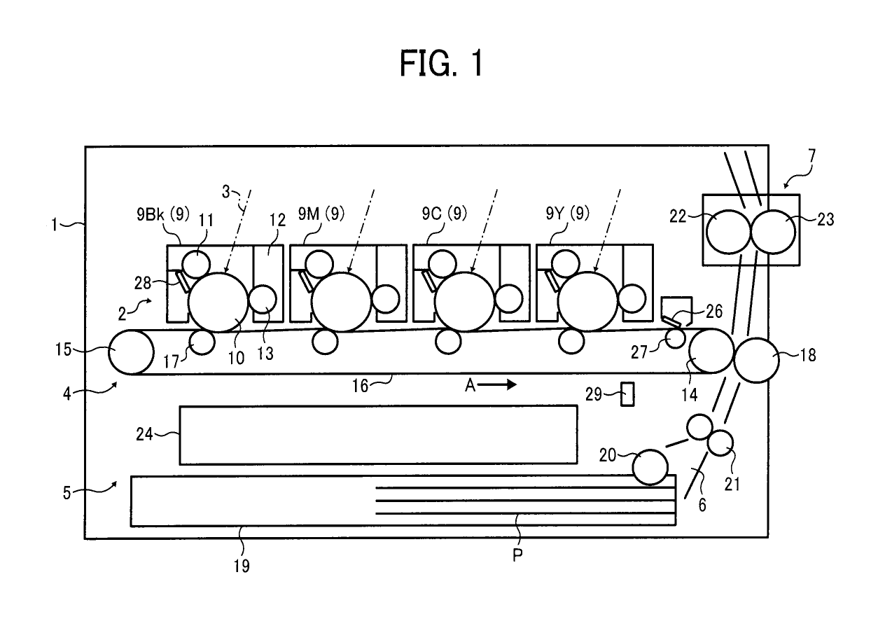

On the center of a color image forming apparatus 1 illustrated in FIG. 1, there is disposed an image forming unit 2 on which four process units 9Y, 9M, 9C, and 9Bk are detachably provided. The process units 9Y, 9M, 9C, and 9Bk have similar configurations except that the process units contain different color developer agents of yellow (Y), magenta (M), cyan (C), and black (Bk), which correspond to the color separation component of a color image.

For example, each of the process units 9 includes: a photoconductor drum 10 that serves as a latent image bearer and is a drum-shaped rotator capable of bearing on a surface thereof toner serving as a developer agent; a charging roller 11 to uniformly charge a surface of the photoconductor drum 10; a developing device 12 having a developing roller 13 serving as a developer agent bearer to supply toner to the surface of the photoconductor drum 10; and a photoconductor cleaning blade 28 and the like to clean the surface of the photoconductor drum 10.

An exposure unit 3 is disposed above each of the process units 9. The exposure unit 3 is structured so as to emit laser light, based on image data.

Immediately below the image forming unit 2, there is disposed a transfer belt device 4 as a belt device. The transfer belt device 4 includes an intermediate transfer belt 16 as an endless belt stretched around a drive roller 14 and a tension roller 15 to be able to run circularly; a primary transfer roller 17 disposed at a position opposite to the photoconductor drum 10 of each of the process units 9 with the intermediate transfer belt 16 therebetween; and other components. Each of the primary transfer rollers 17 presses at each of their positions an inner circumferential surface of the intermediate transfer belt 16, and a primary transfer nip is formed at a place at which each of the photoconductor drums 10 is in contact with a part of the intermediate transfer belt 16 at which the intermediate transfer belt 16 is pressed.

Further, a secondary transfer roller 18 is disposed to face the drive roller 14, which drives the intermediate transfer belt 16, having the intermediate transfer belt 16 therebetween. The secondary transfer roller 18 presses an outer circumferential surface of the intermediate transfer belt 16, and a secondary transfer nip is formed at a place at which the secondary transfer roller 18 and the intermediate transfer belt 16 are in contact with each other.

A cleaning blade 26 as a cleaner to clean the surface of the intermediate transfer belt 16 is in contact with an outer circumference, on the right end side of FIG. 1, of the intermediate transfer belt 16. The cleaning blade 26 is formed of, for example, urethane rubber or the like; however, the material is not limited to urethane rubber if a predetermined contact pressure can be created against the intermediate transfer belt 16. Further, a cleaning opposite roller 27 is provided to be in contact with the intermediate transfer belt 16 at a position facing the cleaning blade 26 from the opposite side of the cleaning blade 26.

As the intermediate transfer belt 16, there is used a resin film-shaped endless belt in which a conductive material such as carbon black is dispersed in vinylidene fluoride (PVDF), ethylene-tetrafluoroethylene copolymer (ETFE), polyimide (PI), polycarbonate (PC), thermoplastic elastomer (TPE), polyester, or the like as a material.

A toner mark sensor 29 is provided to face the intermediate transfer belt 16. The toner mark sensor 29 measures, using a specular reflection type sensor or a diffusion type sensor, a toner image density and a position of each color on the intermediate transfer belt 16 with to adjust the image density and the color.

Below the intermediate transfer belt 16, there is provided a waste toner container 24.

A sheet feeder 5 is located below the image forming apparatus 1 and is constituted by: a sheet feed tray 19 containing sheets of paper P as a recording medium; a sheet feed roller 20 to feed out the sheets P from the sheet feed tray 19; and other components.

A conveyance passage 6 is a conveyance path which conveys the sheet P fed out from the sheet feeder 5 and on which paired conveyance rollers in addition to paired registration rollers 21 are appropriately disposed halfway on the conveyance passage 6 to a sheet ejection unit.

A fixing unit 7 has a fixing roller 22 heated by a heat source, a pressure roller 23 capable of pressing the fixing roller 22, and the like.

The image forming unit 2, the exposure unit 3, the transfer belt device 4, and the like constitute an image forming device to form an image on the sheet P.

Hereinafter, a basic operation of the above image forming apparatus 1 will be described referring to FIG. 1.

In the image forming apparatus 1, when an image forming operation is started, an electrostatic latent image is formed on the surface of the photoconductor drum 10 of each of the process units 9Y, 9C, 9M, and 9Bk. The pieces of image information exposed on the photoconductor drums 10 by the exposure units 3 are each image information in a single color of yellow, cyan, magenta, and black that are separated from a desired full-color image. An electrostatic latent image is formed on each of the photoconductor drums 10, and toner stored in the developing devices 12 is supplied to the photoconductor drum 10 by the developing roller 13 in a drum shape, so that the electrostatic latent image becomes visible as a toner image, which is a visible image. Residual toner after transfer is removed by the photoconductor cleaning blade 28 and is stored in the waste toner container 24 through a toner delivery tube.

In the transfer belt device 4, the drive roller 14 rotates to make the intermediate transfer belt 16 run in the direction indicated by arrow A in FIG. 1. Further, to each primary transfer rollers 17 is applied a voltage that is constant-voltage controlled or constant-current controlled and has the opposite polarity to the charge polarity of the toner is applied. This voltage forms a transfer electric field in each of the primary transfer nips, and the toner image formed on each of the photoconductor drum 10 is sequentially transferred and stacked on the intermediate transfer belt 16 at each of the primary transfer nips.

On the other hand, on the lower part of the image forming apparatus 1, after the image forming operation is started, the sheet feed roller 20 of the sheet feeder 5 rotates to feed out the sheet P stored in the sheet feed tray 19 to the conveyance passage 6. The sheet P fed out to the conveyance passage 6 is conveyed to the secondary transfer nip between the secondary transfer roller 18 and the drive roller 14 while being synchronized by a registration roller 21. At this time, a transfer voltage having the opposite polarity to a toner charge polarity of the toner image on the intermediate transfer belt 16 is applied, so that a transfer electric field is formed in the secondary transfer nip. The toner image on the intermediate transfer belt 16 is collectively transferred onto the sheet P by the transfer electric field formed on the secondary transfer nip.

The residual toner on the intermediate transfer belt 16 that is not transferred to the sheet P is removed by the cleaning blade 26 and is then stored in the waste toner container 24 through the toner delivery tube. At this time, because the intermediate transfer belt 16 is stretched around the cleaning opposite roller 27 at the position facing the cleaning blade 26, the cleaning blade 26 easily scrapes off the residual toner.

The sheet P to which the toner image is transferred is conveyed to the fixing unit 7, and the sheet P is heated and pressed by the fixing roller 22 and the pressure roller 23, whereby, the toner image is fixed on the sheet P. Then, the sheet P on which the toner image is fixed is separated from the fixing roller 22 and is ejected to the outside of the machine by sheet ejection rollers.

In the above, the description is given on the image forming operation for forming a full-color image on the sheet P; however, it is also possible to use only one of the four process units 9Y, 9C, 9M, and 9Bk to form a monochromatic image or to use two or three of the process units 9 to form an image in two or three colors.

Next, the configuration of the intermediate transfer belt according to the present embodiment and the peripheral thereof is described below in comparison with a comparative example.

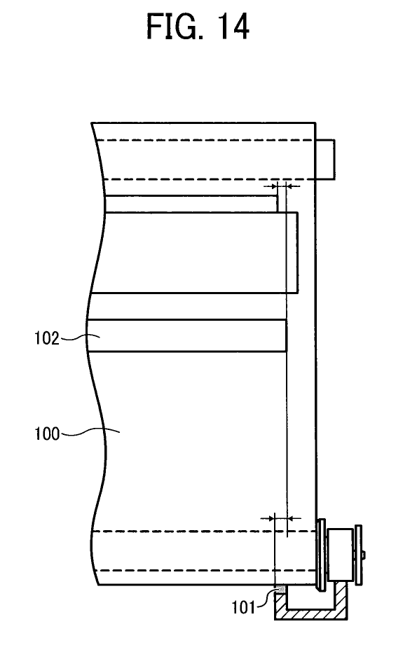

FIG. 14 is a partial view of an image forming apparatus according to a comparative example. In the comparative example, the image forming apparatus includes a conveyance belt 100, pressers 101 that are in contact with both ends of the conveyance belt 100 to press the surface of the conveyance belt 100, and a cleaner 102 to clean the surface of the conveyance belt 100.

In the lateral direction of the conveyance belt 100, the presser 101 is disposed on the inner side of each end of the cleaner 102. In the direction of conveyance of the conveyance belt 100, the inner end of each presser 101 is disposed within an area in which the cleaner 102 has cleaned untransferred residual toner and other dust on the conveyance belt 100. Such a configuration prevents wearing of the conveyance belt 100 scattering of toner due to collision of residual toner with the pressers 101.

On the ends of such a cleaner in contact with the belt, seals are provided to prevent the cleaned toner from spilling outside. In such a configuration, toner may be scattered in the cleaner.

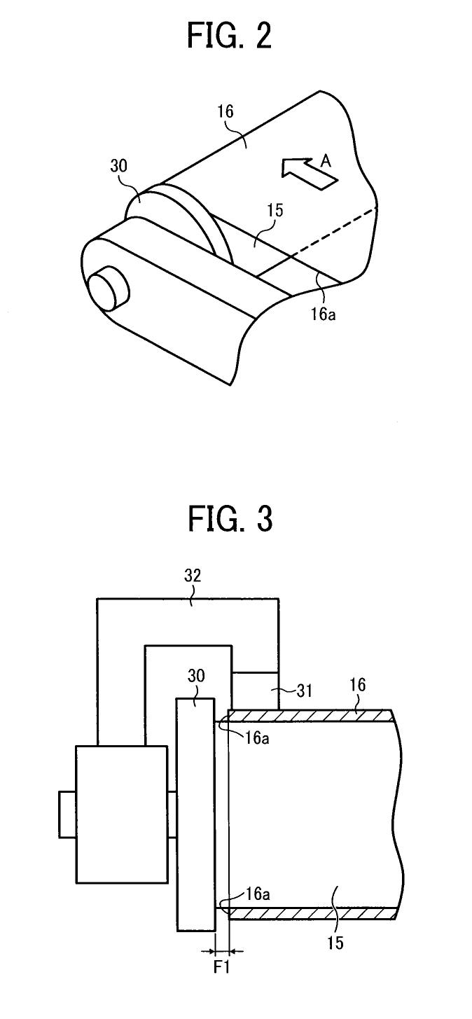

For the image forming apparatus 1 according to this embodiment of the present disclosure, as illustrated in FIG. 2, the tension roller 15 is provided with, on the outer side positions of the lateral ends 16a (hereinafter, also referred to as “ends 16a”) of the intermediate transfer belt 16, flanges 30 as stoppers that restrict the movement of the intermediate transfer belt 16 in a lateral direction (lateral width direction) of the intermediate transfer belt 16, where the lateral direction of the intermediate transfer belt 16 refers to a direction perpendicular to the direction of conveyance of the intermediate transfer belt 16 and is the same direction as an axial direction of the tension roller 15. The flanges 30 are configured with, for example, members made of metal, and are disposed to be rotatable together with the tension roller 15.

Since the flanges 30 are provided, the intermediate transfer belt 16 is controlled not to move in the lateral direction of the intermediate transfer belt 16 when circularly running in the direction indicated by arrow A, and is thus prevented from snaking. Although such an advantageous effect is achieved, the provided flanges 30 can create issues, one of which is that the lateral ends 16a of the intermediate transfer belt 16 are brought into contact with the flanges 30 so that the whole of the belt becomes uneven, and the other of which is that the ends 16a strongly come into contact with the flanges 30 so that the ends 16a are worn.

To address these issues, as illustrated in FIG. 3, on the lateral ends 16a of the intermediate transfer belt 16 of the present embodiment, there are provided pressers 31 to be in contact with the belt surface from above the intermediate transfer belt 16. The pressers 31 are held by holders 32.

The pressers 31 press the intermediate transfer belt 16 in the thickness direction of the intermediate transfer belt 16 and from the surface side of the intermediate transfer belt 16 so as to prevent or reduce the unevenness to be created in the intermediate transfer belt 16. Further, since the intermediate transfer belt 16 does not easily move in the lateral direction due to the pressing force of the pressers 31, the ends 16a are prevented from strongly coming into contact with the flanges 30. The pressers 31 are disposed such that the pressers 31 press the intermediate transfer belt 16 at the positions close to the ends 16a which are in contact with the flanges 30.

There is provided a first space F1 having a predetermined span between the lateral end 16a of the intermediate transfer belt 16 and the flange 30. With this arrangement, even if the intermediate transfer belt 16 snakes a little when running circularly, the end 16a does not immediately collide with the flange 30.

Further, there is a large difference in thermal expansion coefficient between the intermediate transfer belt 16 made of resin material and the flanges 30 made of metal, and the intermediate transfer belt 16 thermally expands more easily. For this reason, the first space F1 provided between the lateral end 16a of the intermediate transfer belt 16 and the flange 30 can prevent the end 16a and the flange 30 from coming in contact with each other, even if there is created a difference in the sizes of the intermediate transfer belt 16 and the flange 30 due to thermal expansion.

Although FIG. 3 illustrates only one side (left side), in the lateral direction, of the intermediate transfer belt 16, the same space as the first space F1 is provided, also in the other side (right side), in the axial direction, between the lateral end 16a of the intermediate transfer belt 16 and the flange 30.

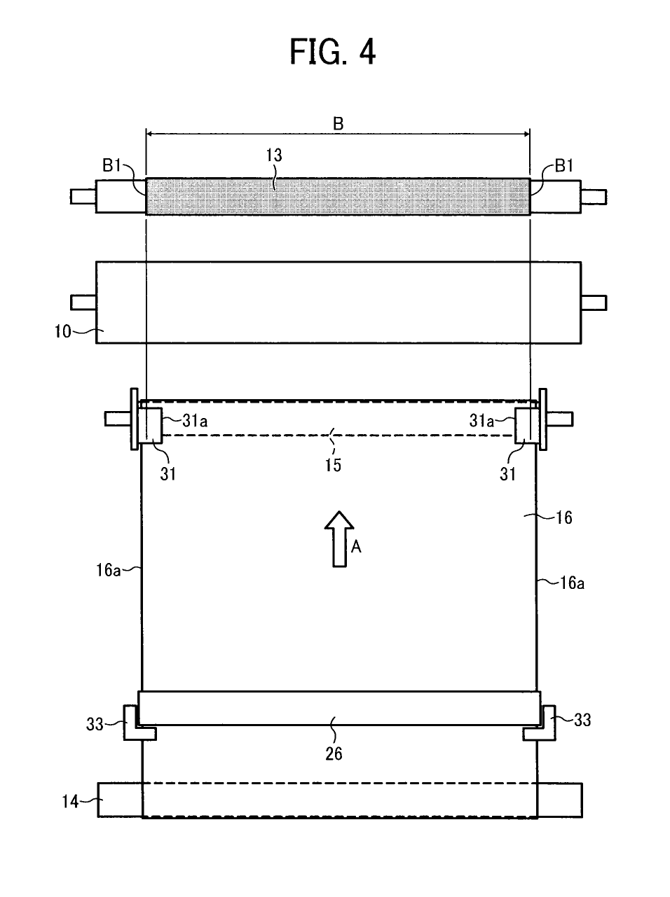

Next, a description will be given on the positional relationships in the lateral direction between the components such as the intermediate transfer belt 16 and the pressers 31. In the following, the arrangement different from the present embodiment is first described referring to FIGS. 4 to 6 to illustrate the problems to be solved by the present embodiment, and the arrangement of the present embodiment is then described.

As illustrated in FIG. 4, the intermediate transfer belt 16 is extended with the both ends in the direction of conveyance being stretched around the drive roller 14 and the tension roller 15. The pressers 31 are provided on the both lateral ends of the intermediate transfer belt 16 at the positions facing the tension roller 15. On the halfway, in the direction of conveyance, of the intermediate transfer belt 16, there is provided the cleaning blade 26 facing the intermediate transfer belt 16, and on the both ends of the cleaning blade 26, there are provided seals 33. The seals 33 are made of, for example, foam material.

Part of each of the seals 33 is disposed on the inner side of the lateral ends 16a of the intermediate transfer belt 16. The seals 33 prevent the toner scraped by the cleaning blade 26 from spilling out from the ends of the cleaning blade 26, and thus prevent the toner from adhering again to the surface of the intermediate transfer belt 16 or the like. The whole of each seal 33 may be disposed on the inner side of the lateral ends 16a of the intermediate transfer belt 16.

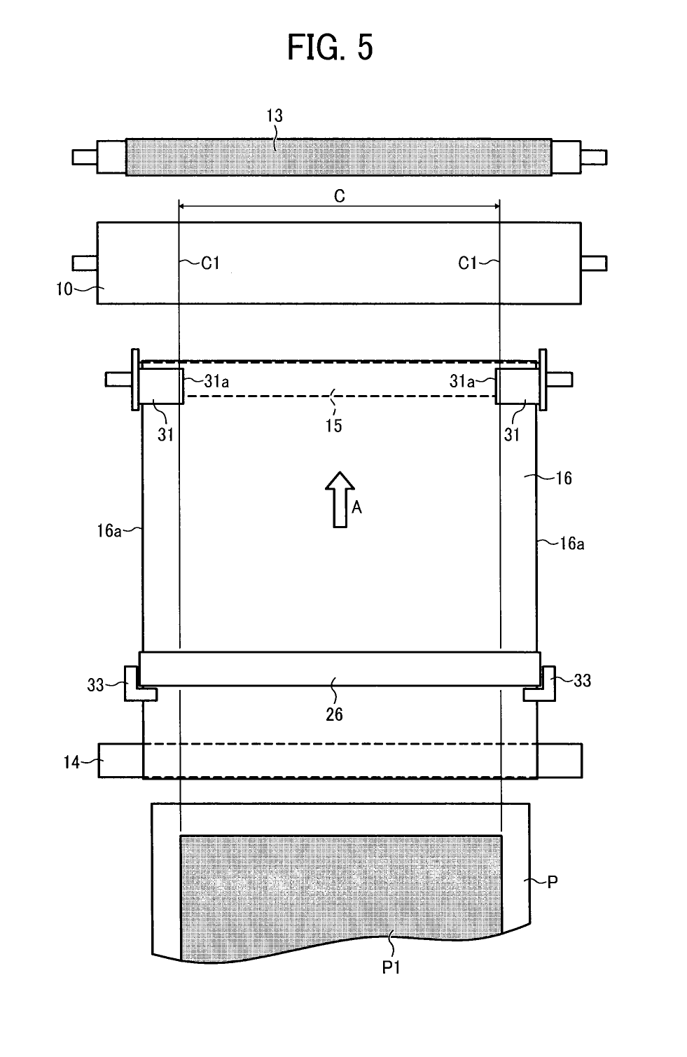

The photoconductor drum 10 is disposed facing the developing roller 13. Since FIG. 4 is a schematic view for illustrating the positional relationships between the components, FIG. 4 does not illustrate the actual arrangement, and the developing roller 13 and the photoconductor drum 10 are arranged in a vertical line for the sake of convenience of comparison with the intermediate transfer belt 16. FIGS. 5, 6, 8, and 10 are also drawn in the same manner.

On the surface of the developing roller 13, there is formed a toner thin layer B serving as a developer layer, so that toner is supplied on the surface of the photoconductor drum 10. Because silica is easily condensed on the lateral ends B1 of the toner thin layer B, when toner is supplied to the photoconductor drum 10 from the developing roller 13, the condensate of silica is adhered to positions corresponding to the lateral ends B1 of the photoconductor drum 10. Thus, the condensate of silica adhered to the photoconductor drum 10 creates a scratch in the photoconductor cleaning blade 28 being in contact with the photoconductor drum 10 (refer to FIG. 1), and this scratch can be a cause to form a toner streak on the surface of the photoconductor drum 10. A toner streak formed on the surface of the photoconductor drum 10 is adhered to the surface of the intermediate transfer belt 16 at the time of a primary transfer.

As described above, the toner streak is adhered to the positions corresponding to the lateral ends B1 of the toner thin layer B on the intermediate transfer belt 16 (the extended lines of the ends B1 of FIG. 4). Further, since the pressers 31 are disposed on the extended lines of the ends B1 in the arrangement of FIG. 4, the circular run of the intermediate transfer belt 16 in the direction indicated by arrow A makes the toner streak adhered to the surface of the intermediate transfer belt 16 collide with the pressers 31, whereby the toner scatters to the periphery. Thus, there arises a disadvantage that such scattering of the toner leads to contamination of a formed images or contamination of peripheral components.

To address the above-described problem, it may be an option to dispose the pressers 31 on the outer side, in the lateral direction, of the toner thin layer B; however, this arrangement creates another disadvantage that the width of the intermediate transfer belt 16 is longer and that the whole of the image forming apparatus 1 is thus larger.

Further, as illustrated in FIG. 5, if inner end faces 31a, serving as inner ends, of the pressers 31 are provided inside, in the lateral direction, of the area corresponding to an image area C (the area, on the intermediate transfer belt 16, sandwiched by the vertical lines drawn from the ends C1 of the image area C of FIG. 5) which corresponds to the maximum width of an image P1 to be formed on the sheet P, the image formed in the range of the image area C on the surface of the intermediate transfer belt 16 collides with the pressers 31, thereby creating a disadvantage that the toner scatters to the periphery and that an abnormal image is formed.

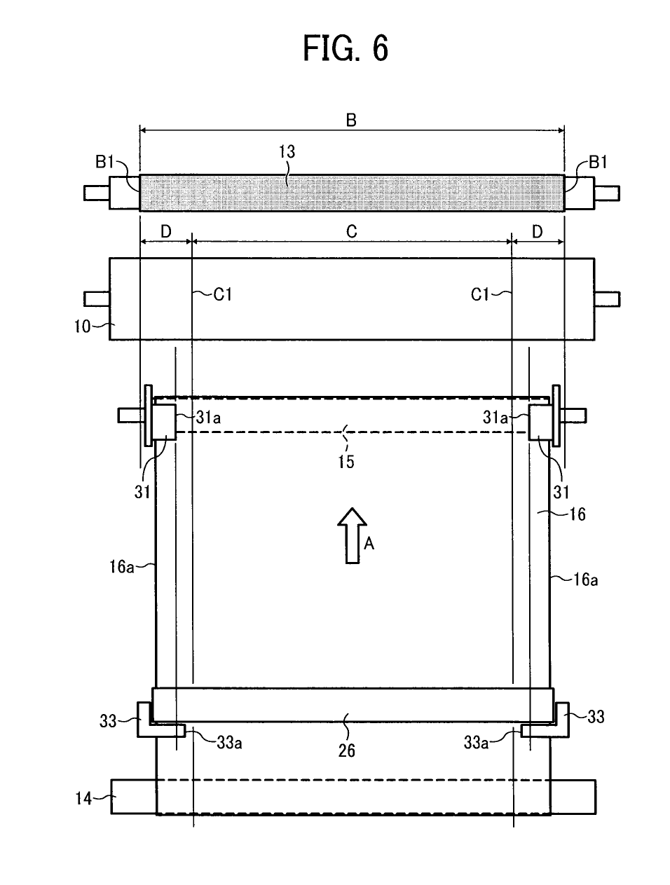

In order to solve the above problem, the configuration illustrated in FIG. 6 can be used. As illustrated in FIG. 6, both ends 16a, of the intermediate transfer belt 16, in the lateral direction, are disposed on the inner side of the lateral ends B1 (the pressers 31 are disposed on the inner side of the lateral ends B1). This arrangement prevents the toner streak formed at the positions corresponding to the lateral ends B1 from adhering to the surface of the intermediate transfer belt 16, and the toner is prevented from being scattered due to the collision of the toner streak with the pressers 31. Further, compared with the case that the pressers 31 are provided outside, of the toner thin layer B, in the lateral direction, the whole width of the provided intermediate transfer belt 16 can be shorter, whereby the intermediate transfer belt 16 and the image forming apparatus 1 can be smaller.

Further, in the arrangement in FIG. 6, the pressers 31 are provided outside the image area C. This arrangement can prevent the pressers 31 from colliding with the image transferred on the surface of the intermediate transfer belt 16.

Here, the photoconductor drum 10 has an exposure area that is an area to be exposed by the exposure unit 3. In the example in FIG. 6 and in the present embodiment, the exposure area is set in the same area as the image area C. Further, the photoconductor drum 10 has background-staining areas D in areas, outside the exposure area, facing the toner thin layer B of the developing roller 13, where the background-staining toner easily adheres to the background-staining areas D.

The charge on the surface of the background-staining areas D provided outside the exposure area is not discharged by a charge remover. Therefore, once toner or the like is directly adhered to the surface of the photoconductor drum 10 due to, for example, contact with the developing roller 13, the adhered toner or the like remains left as the background-staining toner. Then, at the time of primary transfer, the background-staining toner is adhered to the areas corresponding to the background-staining areas D of the surface of the intermediate transfer belt 16 from the surface of the photoconductor drum 10.

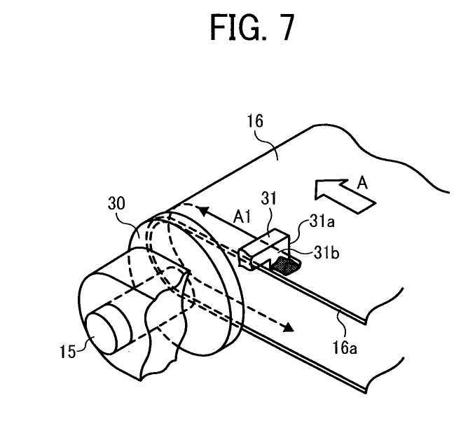

As described above, even in the case that the pressers 31 are provided, as illustrated in FIG. 6, at the positions on which no toner streak is formed and which are outside the image formation area, the background-staining toner is deposited on the surface of the pressers 31 due to the pressers 31 provided on the areas corresponding to the background-staining areas D. Specifically, as illustrated in FIG. 7, the small amount of background-staining toner transferred from the photoconductor drum 10 to the surface of the intermediate transfer belt 16 is deposited on the upstream side faces 31b of the pressers 31.

Then, when the deposited toner becomes more than a certain amount and then overflows from the upstream side faces 31b, the agglomerate of the overflown toner flows in the direction indicated by arrow A1 along with the circular run of the intermediate transfer belt 16 in the direction indicated by arrow A in FIG. 7. At this time, the toner agglomerate flows on the inner side, in the lateral direction, of the inner end faces 31a of the pressers 31. The toner agglomerate flowing on the inner side, in the lateral direction, of the inner end faces 31a collides with the seals 33 illustrated in FIG. 6 and is scattered in the periphery.

In the case of the normally charged toner, force is applied to the toner so that the toner is electrostatically adhered to the intermediate transfer belt 16; thus, the toner is attracted to the side of the intermediate transfer belt 16, and the toner easily passes through under the pressers 31, whereby the toner is hardly deposited on the upstream side faces 31b of the pressers 31 and the toner agglomerate is hardly created. However, in the case of the background-staining toner, the toner is electrostatically adhered to the intermediate transfer belt 16 with such a small force that the toner is easily deposited on the upstream side faces 31b; therefore, scatter of toner particularly due to the collision of the toner agglomerate with the seals 33 can be a disadvantage.

To address this problem, it is possible to expand the exposure area to the background-staining areas D so as to prevent creation of the background-staining toner. However, in order to expand the exposure area, the exposure unit 3 needs to be larger.

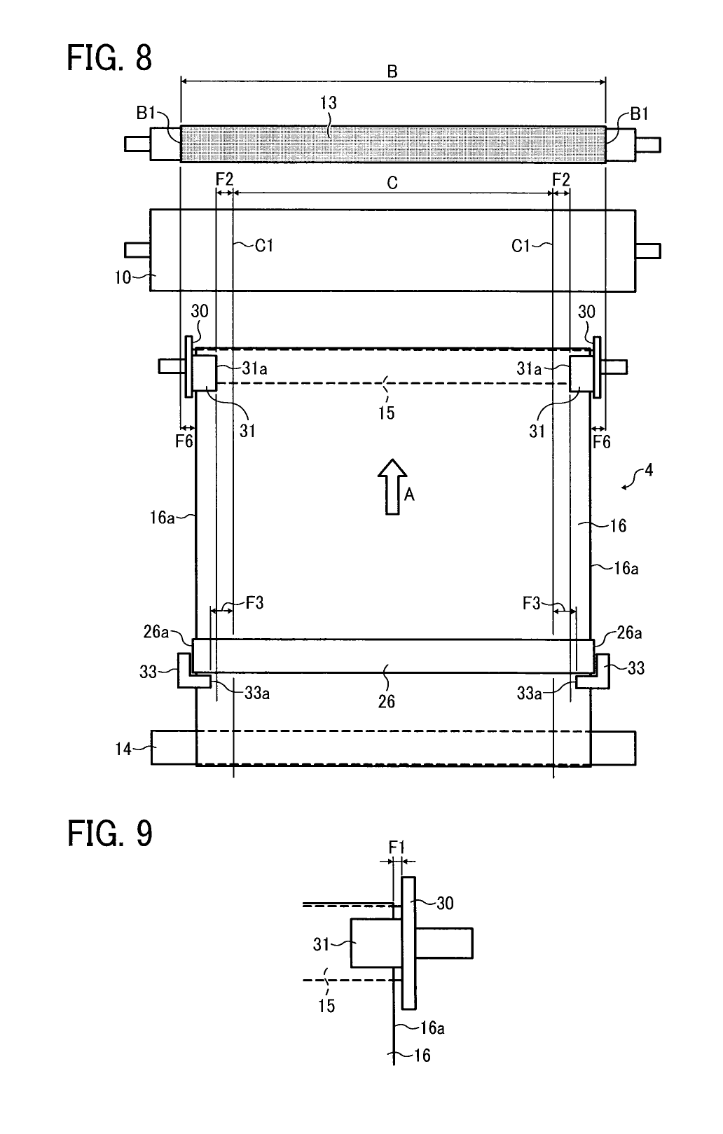

To address this issue, in the transfer belt device 4 of the present embodiment illustrated in FIG. 8, the inner end faces 33a, which are the inner ends of the seals 33, are disposed outside the inner end faces 31a of the pressers 31.

This arrangement prevents a toner agglomerate from colliding with the seals 33 even if the toner agglomerate overflows from the pressers 31 and flows on the inner side of the inner end faces 31a. Therefore, even if the exposure area is set to have the same width as the image area C as described in the present embodiment, the toner is prevented from colliding with the seals 33, whereby the scatter of toner due to the collision can be prevented, and at the same time, the exposure unit 3 can be downsized.

The present embodiment of FIG. 8 has the same arrangement as the example of FIG. 6, in which arrangement the lateral ends 16a of the intermediate transfer belt 16 are disposed on the inner side of the lateral ends B1 of the toner thin layer B so as to avoid a toner streak. However, in the present embodiment, sixth spaces F6 each having a predetermined span are provided between the ends 16a and ends B1.

Here, as illustrated in FIG. 9 (FIG. 9 is an enlarged view of the periphery of one of the flanges 30 of FIG. 8), the first space F1 is provided between the flange 30 and the lateral end 16a of the intermediate transfer belt 16. Even if the intermediate transfer belt 16 is positionally deviated from the regular position in the lateral direction, due to, for example, snaking while circularly running, the end 16a comes into contact with the flange 30; thus, the end 16a is not positionally deviated to the outer side of the flange 30, whereby the maximum value of the positional deviation amount is equal to the distance of the first space F1.

Further, each of the sixth spaces F6 is set longer than the distance of the first space F1 (in other words, the ends B1 are disposed on the outer side, in the lateral direction, of the inner end faces of the flanges 30). With this arrangement, even if the intermediate transfer belt 16 is positionally deviated in the lateral direction, the amount of the positional deviation is not greater than the distance of the sixth spaces F6. Thus, the lateral end 16a of the intermediate transfer belt 16 can be maintained to be on the inner side of the lateral ends B1 of the toner thin layer B.

Further, the pressers 31 are provided on the outside, in the lateral direction, of the image area C in the present embodiment of FIG. 8, and this arrangement is the same as in the example of FIG. 6. In the present embodiment, second spaces (fourth spaces) F2 each having a predetermined span are provided between the lateral ends C1 of the image area C and the inner end faces 31a of the pressers 31, and each of the second spaces F2 is set longer than the distance of the first space F1. With this arrangement, even if the intermediate transfer belt 16 is positionally deviated, the pressers 31 are maintained to be on the outside, in the lateral direction, of the image area C. In the present embodiment, since the image area C and the exposure area are the same, the same relationship exists also between the exposure area and the pressers 31.

Further, in the present embodiment, the seals 33 are provided on the outside, in the lateral direction, of the image area C in the same manner as the pressers 31. This arrangement prevents the residual toner adhered to the surface of the intermediate transfer belt 16 from being adhered to the seals 33 after the secondary transfer from the intermediate transfer belt 16.

Further, the third spaces (the fifth spaces) F3 each having a predetermined span are provided between the seals 33 and the lateral ends C1 of the image area C, and each of the third spaces F3 is set longer than the distance of the first space F1. With this arrangement, even if the intermediate transfer belt 16 is positionally deviated in the lateral direction, the seals 33 are maintained to be on the outside, in the lateral direction, of the image area C. In the present embodiment, since the image area C and the exposure area are the same, the same relationship exists also between the exposure area and the seals 33.

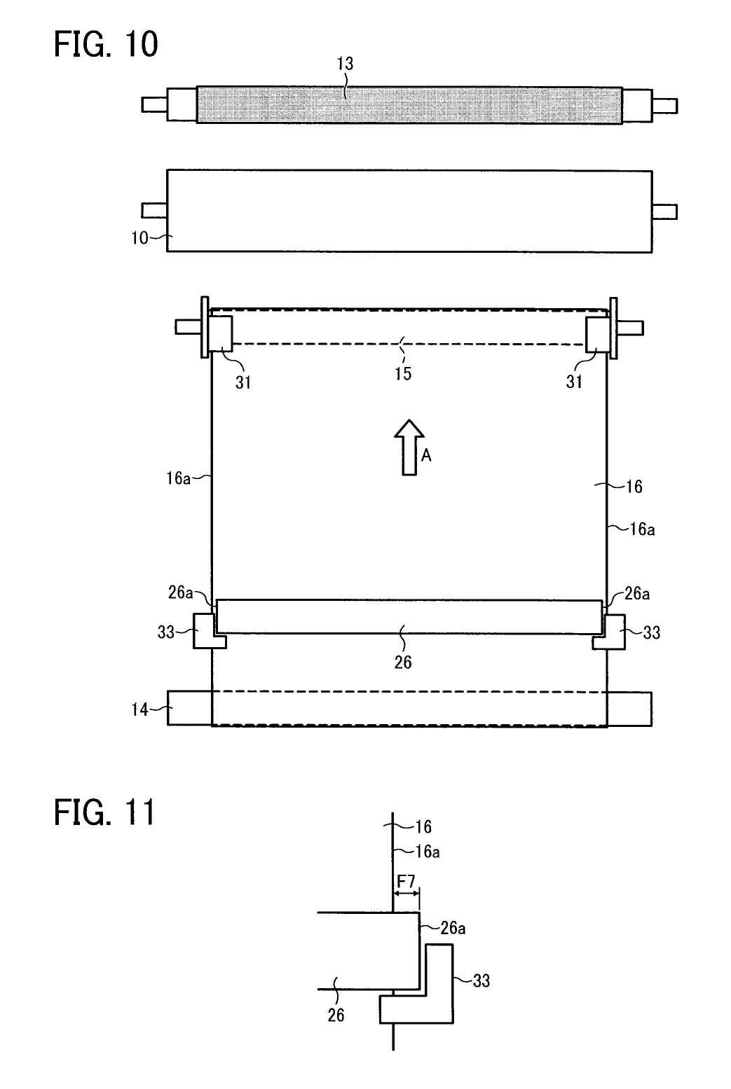

In the present embodiment, the lateral ends 26a (hereinafter, also referred to simply as “ends 26a”), in the lateral direction, of the cleaning blade 26 are provided on the outer side of the lateral ends 16a of the intermediate transfer belt 16. If it is assumed that the cleaning blade 26 is provided on the inner side of ends 16a of the intermediate transfer belt 16 as illustrated in FIG. 10, the toner overflown from the ends 26a of the cleaning blade 26 flows in the direction indicated by arrow A and collides with the pressers 31, so that the toner scatters.

In the present embodiment, in order to prevent the above scatter of toner, the ends 26a of the cleaning blade 26 are disposed on the outer side of the lateral ends 16a of the intermediate transfer belt 16 as illustrated in FIG. 11.

The seventh spaces F7 each having a predetermined span are provided between the ends 26a of the cleaning blade 26 and the lateral ends 16a of the intermediate transfer belt 16. Each of the seventh spaces F7 is set longer than the distance of the first space F1. With this arrangement, even if the intermediate transfer belt 16 is positionally deviated in the lateral direction, the lateral ends 26a of the cleaning blade 26 can be maintained to be on the outer side of the lateral ends 16a of the intermediate transfer belt 16.

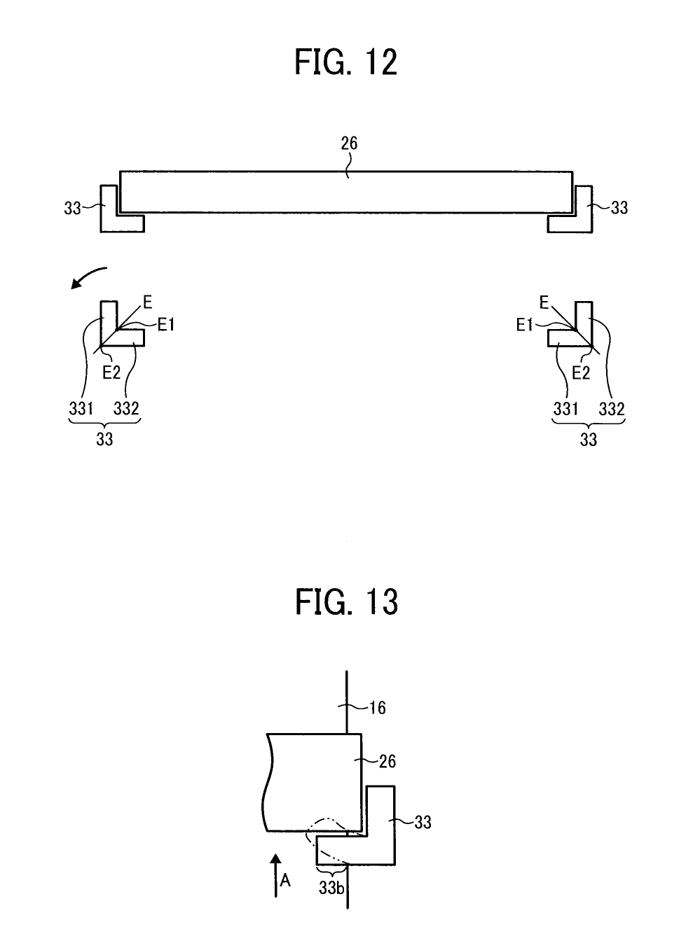

As illustrated in FIG. 12, each of the seals 33 of the present embodiment is L-shaped and is line-symmetric with respect to the central line E. Specifically, referring to the seals 33 on the left side of FIG. 12, the seal 33 has an L-shape made of a first part 331 serving as a vertical part provided in the direction of conveyance (the top-bottom direction in FIG. 12) of the intermediate transfer belt 16 and a second part 332 serving as a horizontal part provided from one end of the first part 331 in the horizontal direction (the left-right direction in FIG. 12). The first part 331 and the second part 332 respectively extend, by the same distance, in the direction of the first part 331 and the direction of the second part 332 from the central line E, on which the first part 331 and the second part 332 are connected to each other, and the seal 33 is in a line-symmetric shape with respect to the central line E. The central line E is a straight line passing through the intersection points E1 and E2 each of which is an intersection point of one of the two vertical lines of the first part 331 and one of the two horizontal lines of the second part 332.

By rotating the seal 33 disposed on the left side of FIG. 12 in the direction indicated by the arrow in FIG. 12 by 90° so as to interchange the orientation of the first part 331 and the orientation of the second part 332 (the first part 331 becomes the horizontal part, and the second part 332 becomes the vertical part), the placement of the seal 33 on the right can be achieved. In this manner, the same seal 33 can be used in the left and light without turning the seal 33 front and back. With this arrangement, for example, even in the case that a decreased-friction layer having abrasion resistance to be described later is provided on only one surface, of the seal 33, facing the intermediate transfer belt 16, the same component can be used for the left and right, thereby achieving reducing the cost reduction.

Further, since the seal 33 is in an L-shape, each of the first part 331 and the second part 332 can cover each of the two sides forming the edge part of the cleaning blade 26, the edge part of the cleaning blade 26 can be covered without a gap.

FIG. 13 is an enlarged view of the peripheral part of the seal 33. A contact portion 33b, of the seal 33, in contact with the intermediate transfer belt 16 is deformed as depicted by the broken line in FIG. 13 and is sandwiched between the cleaning blade 26 and the intermediate transfer belt 16 due to the friction force created between the seal 33 and the intermediate transfer belt 16 circularly running in the direction indicated by arrow A; thus, the seals 33 can be worn or peeled off.

To address this issue, a resin member made of, for example, polyethylene terephthalate (PET) can be adhered to the surface of the seal 33 made of foam material so that the seal 33 is in a two-layer structure configured with a foam layer made of foam material and a resin layer made of a resin material. The provided resin layer can make the seal 33 stiffer and prevent the contact portion 33b from being deformed, thereby preventing such a deformation of the seal 33 as in FIG. 13. The resin layer made of a resin material is set to have the same L-shape as the seals 33 and to have the thickness of not less than 0.05 mm and not more than 0.35 mm. In the case that the resin layer is made to have the same shape as the seal 33, cost reduction can be achieved for a reason, for example, that resin layer and the seal 33 can be simultaneously formed by using a punch die.

Further, in order to reduce the friction force created between the seal 33 and the intermediate transfer belt 16, a decreased-friction layer made of felt or the like, which has high slidability and a decreased friction coefficient, may also be provided on the side, of the seal 33, in contact with the intermediate transfer belt 16. The decreased-friction layer is provided so as to cover the entire surface, of the seal 33, facing the intermediate transfer belt 16.

If the decreased-friction layer is formed of felt, the presser 31 is preferably configured with a member made of felt in the same manner as the decreased-friction layer. With this arrangement, even if felt scraped off by the friction force between the seal 33 and the intermediate transfer belt 16 is flown by the circular run of the intermediate transfer belt 16 and gets into the presser 31, the felt does not get into the presser 31 as a foreign substance since the presser 31 is made of felt in the same manner as the seal 33.

Further, the seal 33 may also be formed in a three-layer structure configured with: a decreased-friction layer made of felt having high slidability; a resin layer that is to make the seals 33 stiffer and is made of PET or the like; and a form layer made of foam material.

An embodiment of the present disclosure is described above; however, the present disclosure is not limited to the above embodiment, and it is a matter of course that various modifications may be made without departing from the scope and spirit of the present disclosure. An image forming apparatus according to the present disclosure is not limited to the color image forming apparatus illustrated in FIG. 1, and includes a monochromatic image forming apparatus, a copier, a printer, a facsimile machine, or a multifunction peripheral equipped with a monochromatic image forming apparatus, a copier, a printer, and a facsimile machine, or the like.

The intermediate transfer belt 16 for the image forming apparatus 1, which is an intermediate transfer type, is described in the present embodiment; however, the present disclosure can be applied to a conveyance belt in a belt-shaped photoconductor and to a conveyance belt that bears a recording medium to which an image is transferred and that conveys the recording medium by circularly running.

In the present embodiment, the flanges 30 are provided on the tension roller 15; however, the flanges 30 may be provided on the drive roller 14.

In the present embodiment, the seals 33 are provided on the both lateral ends of the cleaning blade 26; however, the seal 33 may be provided only on any one of the both ends.

In the present embodiment, the image area C, which is the maximum width of an image formed on a sheet P in the with direction of the intermediate transfer belt 16, is the same as the exposure area of the photoconductor drum 10; however, the exposure area may be made wider in the lateral direction than the image area.

In the present embodiment, the first spaces F1, which are the spaces between the flanges 30 and the lateral ends 16a of the intermediate transfer belt 16, are set the same for the right and lent ends; however, the first spaces F1 may be different between the right and left ends. In this case, regarding the second spaces (the fourth spaces) F2, the third spaces (the fifth spaces) F3, the sixth spaces F6, and the seventh spaces F7, those spaces are set, for the right and left sides, longer than the first space F1, which are different between the right and left ends.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A belt device comprising:
an endless belt to bear an image or a recording medium to which an image is transferred;
a presser disposed in contact with each end of the belt in a lateral direction of the belt;
a cleaner to contact the belt to clean a surface of the belt; and
a seal disposed on one end or both ends of the cleaner in the lateral direction of the belt, the seal having an inner end inside the belt in the lateral direction of the belt;
wherein an exposure area is disposed on an inner side of each end of the belt in the lateral direction of the belt, and
the presser and the seal are disposed on an outer side of an image area, in which an image is formed, and on an outer side of the exposure area in the lateral direction of the belt.

2. The belt device according to claim 1,
wherein the belt is an intermediate transfer belt to which a developer agent image is transferred from a latent image bearer, and
wherein the exposure area is an area of a surface of the latent image bearer that is exposed by an exposure unit in the lateral direction of the belt.

3. The belt device according to claim 1,
wherein the inner end of the seal is disposed at the same position as a position of an inner end of the presser or on an outer side of the inner end of the presser in the lateral direction of the belt.

4. The belt device according to claim 3,
wherein a fourth space having a predetermined span is provided between the inner end of the presser and an end of the exposure area in the lateral direction of the belt,
wherein a fifth space having a predetermined span is provided between the inner end of the seal and the end of the exposure area, and wherein each of the fourth space and the fifth space is longer than the first space in the lateral direction of the belt.

5. The belt device according to claim 1,
wherein, in the lateral direction of the belt, each end of the belt is disposed on an inner side of an area corresponding to a developer layer that is a layer of a developer agent borne on a surface of the developer agent bearer to supply the developer agent to the latent image bearer.

6. The belt device according to claim 5,
wherein a sixth space having a predetermined span is provided between an end of the area corresponding to the developer layer and each end of the belt in the lateral direction of the belt, and
wherein the sixth space is longer than the first space in the lateral direction of the belt.

7. The belt device according to claim 1,
wherein said both ends of the cleaner are disposed outside the belt in the lateral direction.

8. The belt device according to claim 7,
wherein a seventh space having a predetermined span is provided between each end of the belt and an end of the cleaner at a same side in the lateral direction of the belt and wherein the seventh space is longer than the first space in the lateral direction of the belt.

9. The belt device according to claim 1, further comprising a stopper disposed on an outer side of each end of the belt in the lateral direction, to restrict movement of the belt in the lateral direction,
wherein a first space having a predetermined span is provided between the stopper and each end of the belt in the lateral direction of the belt.

10. The belt device according to claim 9,
wherein a second space having a predetermined span is provided between an inner end of the presser and an end of the image area in the lateral direction of the belt,
wherein a third space having a predetermined span is provided between the inner end of the seal and the end of the image area in the lateral direction of the belt, and
wherein each of the second space and the third space is longer than the first space in the lateral direction of the belt.

11. The belt device according to claim 1,
wherein the seal has a multi-layer structure including a foam layer made of foam material and a resin layer made of resin material, and
wherein the foam layer and the resin layer have an identical shape.

12. The belt device according to claim 11,
wherein the resin layer is made of polyethylene terephthalate.

13. The belt device according to claim 11,
wherein the resin layer has a thickness of not less than 0.05 mm and not more than 0.35 mm.

14. The belt device according to claim 1,
wherein the seal includes a decreased-friction layer disposed on a face of the seal facing the belt, and
wherein the decreased-friction layer is made of material having a decreased friction coefficient and fully covers the face facing the belt.

15. The belt device according to claim 14,
wherein the decreased-friction layer is made of the same material as the presser.

16. The belt device according to claim 14,
wherein the low-friction layer is made of felt.

17. The belt device according to claim 1,
wherein the seal has an L-shape in which a vertical part and a horizontal part are connected at one end of each of the vertical part and the horizontal part.

18. The belt device according to claim 17,
wherein the vertical part and the horizontal part of the seal extend, by an equal distance, in a direction of the vertical part and in a direction of the horizontal part, respectively, from a central line on which the vertical part and the horizontal part are connected to each other, and wherein the seal has a line-symmetric shape with respect to the central line.

19. The belt device according to claim 1,
wherein the image area and the exposure area have an equal width in the lateral direction of the belt.

20. An image forming apparatus comprising the belt device according to claim 1.
